(19) United States
(12) Patent Application Publication
(10) Pub. No.: US 2001/0045688 A1
(43) Pub. Date: Nov. 29, 2001

(54) Motor controlled mold pin actuator

(76) Inventor: Kent W. Royer, Williamsburg, OH (US)

Correspondence Address: MILACRON INC., 2090 FLORENCE AVE., CINCINNATI, OH, 45206, US

(21) Appl. No.: 09/775,078

(22) Filed: Feb. 1, 2001

Related U.S. Application Data
(60) Provisional application No. 60/179,661, filed on Feb. 2, 2000.

(51) Int. Cl. B29C 45/14

(52) U.S. Cl. 264/278

(57) ABSTRACT

An improved golf ball injection process and mold uses electrically driven part ejection mechanisms as actuators to control retractable core pins that support a preformed core in a spherical mold cavity. The electrically driven, actuator controlled pins can be precisely and independently controlled in both the upper and lower mold segments to achieve the desired positioning and velocities in the vertical axis, with varying degrees of pinch to hold the spherical core inserts. The forward and retract position of the core pins, as well as the ability to profile pin velocities, can be easily adjusted by the molding machine's computer process controller without changing mechanical stops internal to the mold. The sequence timing can be set so that the core insert can be suspended and encapsulated by plastic with varying timing, allowing for the core insert to be shifted during the molding process.

### CROSS-REFERENCE TO RELATED APPLICATION

This application claims the benefit of U.S. Provisional Application No. 60/179,661, filed Feb. 2, 2000.

### BACKGROUND OF THE INVENTION

1. Field of the Invention

The present invention relates generally to the molding of a cover layer over a preformed core to manufacture a golf ball and, more particularly to an improved method for controlling the molding process as it relates to centering the core insert within the mold cavity.

2. Description of the Related Art

In the golf ball manufacturing process, it is a common practice to form the cover of the ball using injection molding. A mold comprising a pair of parallel plates containing opposed hemispherical cavities is used to form a spherical cavity within which a previously formed golf ball core is suspended by retractable pins within the mold construction. The retractable pins must be accurately set at a forward position to suspend the ball core properly, while often using a pinching effect to prevent movement of the core while the thermoplastic material for the cover is injected and flows around the insert. Current methods use piston/cylinder devices (hydraulic or pneumatic) to position the pins and incorporate mechanical stops to limit the extension and retraction of the pins. Adjustment of the mechanical stops for the pins is critical to producing a ball with a properly centered core and often requires removal and/or disassembly of the mold.

The runner that conveys the plastic material for the cover to the mold cavity is typically provided around the parting line defined where the hemispherical cavities terminate at the surface of the molding plates. Gates connect the runner with the cavities. While the thermoplastic material is supplied to the cavity via a runner and a plurality of gates within the mold, the retractable pins are retracted to their full reverse position. The variation of the timing and speed of this process determines the consistency and accuracy of centering the core in the golf ball. After the thermoplastic material sets, the plates are separated and the golf ball is removed from the cavity.

Injection molds for forming golf balls are well known in patented prior art. Prior related U.S. patents include U.S. Pat. Nos. 5,147,657; 5,122,046; and 4,959,000 covering different aspects of the mold design, including retractable pins. While the prior devices operate satisfactorily, they still possess inherent drawbacks related to setting the positions and speeds of the retractable pins.

### SUMMARY OF THE INVENTION

The present invention was developed in order to overcome the drawbacks of prior golf ball molds and associated manufacturing processes, while improving the quality of the golf ball and enhancing automation capabilities. Accordingly, an objective of the present invention is to provide an improved method for controlling the molding process for a golf ball as it relates to centering the preformed core insert. Another objective of the invention is to reduce the change-out time required for presetting positions of the retractable pins which center the core within the mold cavity. Still another objective of the invention is to achieve accurate, independent speed control of both the upper and lower retractable pins in the mold for a golf ball.

This invention accomplishes these objectives by providing a process of molding golf balls that improves on the amount of time required to make adjustment to the position and pinch of the various sizes of spherical core inserts in a golf ball mold, while providing additional flexibility of precision control for the retract speeds of the retractable pins. More specifically, the improved golf ball injection process of the present invention incorporates electrically driven mechanical actuators for the retractable pins in the upper and lower mold plates that together define a spherical cavity for the finished golf ball. The electric motors for the actuators and/or the actuators themselves can be mounted on the injection molding machine or directly on the mold, to control the positioning of a plurality of retractable core pins that extend into each hemispherical segment of the mold cavity to support a preformed core for a golf ball. Preferably, the electrically driven eject mechanisms typically provided on an all-electric injection molding machine function as the electrically driven actuators of the invention, thereby minimizing system cost by using the molding machine's eject motor control to actuate the pins.

The mechanical stops of a conventional golf ball mold must either be modified or removed so that the necessary modifications to the lower and upper ejector plates of the mold can be made to incorporate the retractable core support pins of the present invention. In addition, the ejector plate of the lower mold segment is modified to incorporate the ejector pins for removal of the runner. In particular, the ejector pin mounting in the ejector plate is designed so that there is no movement of the ejector pins while the retractable pins that hold the core insert are moved to their forward position. The forward limit of the stroke of the retractable pins, as accomplished by the associated upper and lower ejector plates, is readily adjusted by the microprocessor based machine control set point parameters. The upper and lower ejector plate positions are achieved and maintained by the electrically controlled actuator connected to each ejector plate, where the actuators are either included as part of the mold assembly or mounted on the injection molding machine.

Independent set points for position of both the upper and lower ejector plates connected to the upper and lower retractable pins are used to shift the core insert along a vertical axis, to allow for proper positioning during the injection process. Additionally, the position set points are also used to create a pre-load (pinch) to the core insert as to prevent premature movement during the injection process. Independent speed settings (velocity) and timers are provided for both the upper and lower electrically controlled actuators. The speed and timing set points provide the flexibility to prevent the core insert from shifting too fast, thereby maintaining proper orientation of the core insert.

There are several advantages in using electrically driven actuators to control the support plates for the retractable pins, as taught by the present invention. First, the actuators can precisely and independently control both position and velocity of the upper and lower retractable core pins. This enables the desired pin movement in the vertical axis, including, for example, pin positioning to accommodate different sizes of core inserts, profiling of pin velocities, and providing varying degrees of pinch to the spherical core insert. In addition, the forward and retract positions of the retractable core pins can be easily adjusted via a computer process controller without disassembly of the mold to change internal mechanical stop settings. Furthermore, the sequence timing of the machine molding process can be set so that the insert can be suspended and encapsulated by plastic with varying timing allowing for the core insert to be shifted during the molding process, if desired. Finally, the pins in the upper and lower mold segments can be set to another position during the finished part extraction phase of the machine cycle, allowing for better separation of the runner and finished parts. This capability facilitates automation for part and runner removal.

### BRIEF DESCRIPTION OF THE DRAWINGS

FIG. 1 is a partial front sectional view of a vertical injection molding machine incorporating upper and lower electrically controlled actuators mechanically connected to the retractable pins of a golf ball mold in accordance with the present invention.

FIG. 2 is a side view of the vertical injection molding machine showing the relative orientation of the injection unit that supplies the thermoplastic material for the golf ball cover into the mold cavity.

FIG. 3 is a diagrammatic, cross-sectional view showing how the upper and lower retractable pins suspend the core insert within the mold cavity.

FIG. 4 is a cross-sectional view of a golf ball mold construction in accordance with the present invention, showing the upper and lower mold halves and the relationship of the ejector plate mounted with the ejector and retractable pins.

FIG. 5 is a plan view taken along line 5-5 of FIG. 1, showing the ejector mechanism of the injection molding machine in greater detail, with certain unrelated parts removed for clarity.

FIG. 6 shows a typical parameter setting screen used by the operator to enter the information required by the machine control to operate the electrically driven actuators for the retractable pins.

FIG. 7 shows a typical timing sequence for controlling an injection molding machine that includes upper and lower actuators for retractable pins in accordance with the present invention.

### DESCRIPTION OF THE PREFERRED EMBODIMENTS

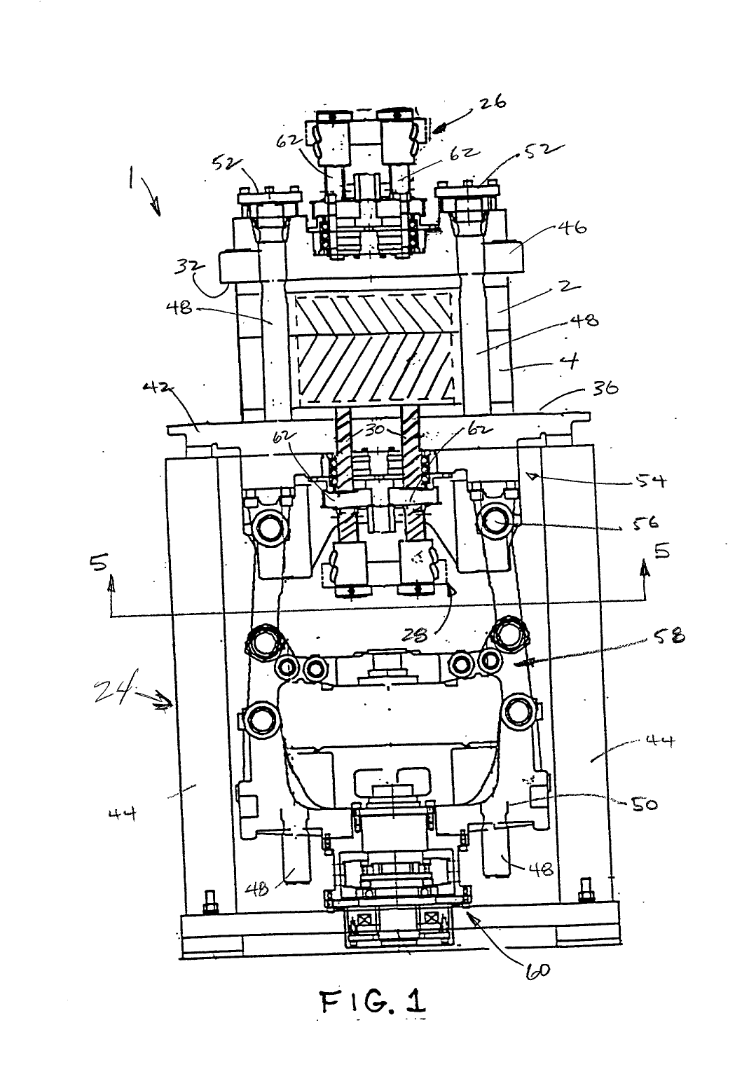

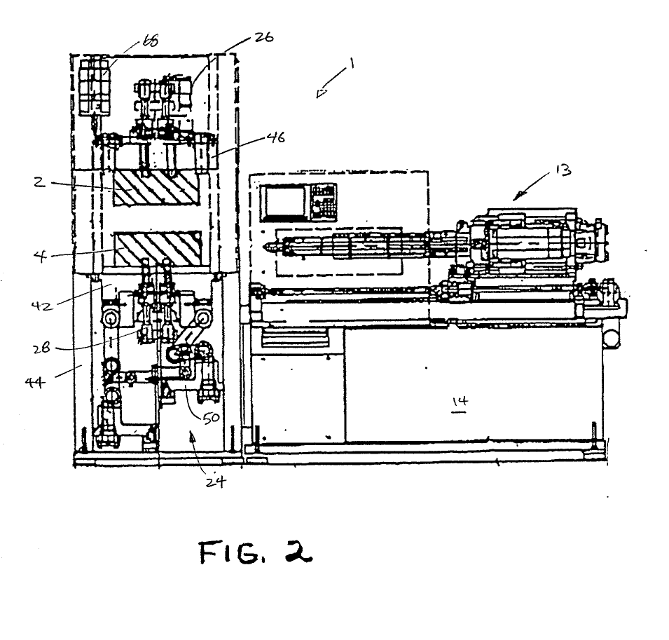

Referring now to the drawings, and particularly to FIGS. 1 and 2, there is shown an injection molding machine 1, the structure of which will be described in some detail to clarify the interaction of the components of the present invention. Specifically, the injection molding machine 1 includes a base 14 that supports an injection unit 13 for plasticating a thermoplastic material into a flowable, viscous state and injecting the plasticated material into a golf ball mold consisting of upper and lower segments 2, 4. The point of injection into the mold is optimized for each molding application and is not restricted to occurring at the parting line of the mold segments 2, 4. In addition, although the injection molding machine shown in the drawings has a vertically oriented, toggle-type clamping mechanism 24, the concepts of the present invention are equally applicable to other injection molding machine constructions and clamp configurations, as known in the plastics processing industry.

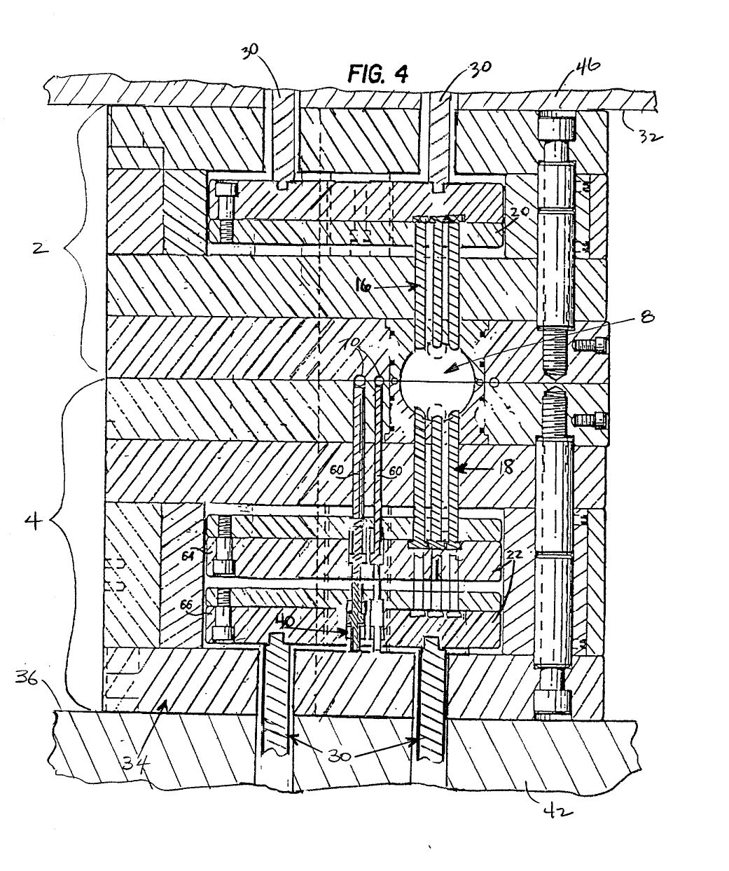

The mold segments 2,4 are mounted in the clamping mechanism 24 of the injection molding machine 1 and movable relative to each other to open and close selectively a spherical mold cavity 8 (see FIG. 4). The clamping device 24 can be either electrically or fluid power driven to provide vertical clamp motion. Electrically driven actuators 26, 28 are preferably provided as independent upper and/or lower ejector assemblies in conjunction with the clamping device 24 of the injection molding machine 1, as shown. Alternatively, the actuators can be included as independent assemblies in the upper and lower mold segments 2, 4.

The mold traversing and clamping mechanism 24 includes a stationary platen 42 connected to vertical frame 44 to support securely the mold segment 4. The mold segment 2 is secured to a moving platen 46 that is attached to tie rods 48 that extend between the moving platen 46 and a toggle support platen 50. The mold traversing and clamping mechanism 24, as shown, is a toggle-type system that acts in conjunction with the tie rods 48 and moving platen 46 to move the mold segment 2 toward and away from the mold segment 4, and securely hold together the mold segments 2, 4 when the plasticated material is injected into and contained within the mold cavity 8 under high pressure. The mold traversing and clamping mechanism 24 is mounted on the vertical frame 44, which is generally rectangular in form and of a construction that is generally known to those skilled in the art. The stationary platen 42, which is a generally rectangular structure, is rigidly secured to the frame 44 and includes a planar face 36 to which the mold segment 4 is securely mounted.

Positioned on the base 14 and adjacent the mold segments 2, 4 is the injection unit 13, which plasticates solid or powder thermoplastic material for the golf ball cover to provide a molten, flowable mass suitable for injection into the mold cavity 8. The injection unit 13 includes a tubular barrel that carries a rotatable screw (not shown) to aid in plasticating the material, to convey material toward the mold cavity 8, and to inject the material into the mold cavity 8 under high pressure. Since the structure and operation of the plastication and injection unit 13 are well known to those skilled in the art and not critical to the understanding of the present invention, no further description of that unit will be provided herein.

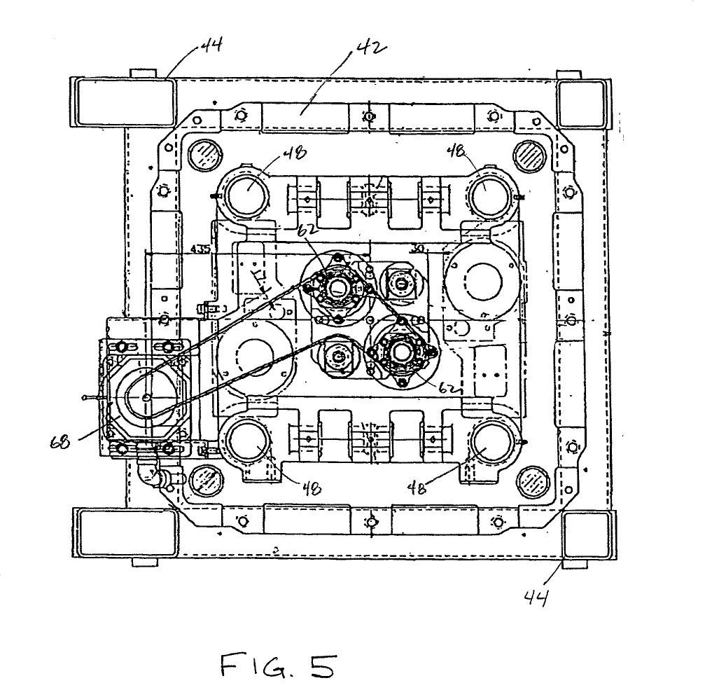

The four parallel tie rods 48 of the clamping mechanism 24 have their respective longitudinal axes disposed in a generally vertical, rectangular array. The tie rods 48 connect to the moving platen 46 by means of nuts 52 (see FIG. 1) and are slidable through appropriately sized bores (see FIG. 5) in the stationary platen 42. The opposite ends of the tie rods 48 connect to the toggle support platen 50, which moves with the moving platen 46 during the molding cycle.

The moving platen 46 is carried on the tie rods 48 for movement by the toggle support platen 50, all of which are movable with respect to the stationary platen 42. The moving platen 46 includes a mold mounting surface 32 that is opposite the face 36 of stationary platen 42, and carries the mold segment 2. The mold segment 2 engages the mold segment 4 to define one or more spherical mold cavities 8 into which the molten thermoplastic material is injected to form the desired parts. The rear face 54 of the stationary platen 42 includes appropriately sized bores to carry rotatable pivot pins 56 that are joined to a toggle linkage 58 connected to the toggle support platen 50. When the toggle linkage 58 is actuated by a motor 60, it acts on the toggle support platen 50 to raise or lower the moving platen 46 with respect to the stationary platen 42.

In FIG. 1, the moving platen 46 is shown in its fully lowered (closed) position relative to the stationary platen 42. The toggle linkage 58 has been operated by the motor 60 to the fully extended position shown. When the moving platen 46 is in the position shown in FIG. 1, the mold segments 2, 4 are in contact and define the mold cavity 8, into which the molten thermoplastic material is injected under high pressure to surround the core with the cover material. The toggle linkage 58 serves to maintain the position of the moving platen 46 relative to the stationary platen 42, so there is no separation of the mold segments 2, 4 due to the force imposed on the surfaces of the mold cavity 8 by the injected material.

After the injection phase of the molding cycle is finished, the toggle linkage 58 is operated in reverse by the motor 60, thereby drawing upward the toggle support platen 50 and tie rods 48. This movement of the tie rods 48 causes the moving platen 46 to likewise move upward, away from the stationary platen 42, to separate the mold segments 2, 4 and permit the molded part to be removed from the mold cavity 8. As shown in FIG. 2, the moving platen 46 is completely raised (open) and is in its furthest position relative to the stationary platen 42.

The upper and lower electric actuators 26, 28 provide multiple functions in connection with the present invention. The configuration of the electric actuators 26, 28 is essentially the same as that generally provided in an all-electric machine to actuate conventional ejector pins. For example, as illustrated, parallel screw and nut assemblies 62 are provided in both of the actuators 26, 28 to convert the rotary output of an electric motor 68 (see FIG. 5) to a linear movement that is transmitted to the ejector plate 22 of the mold assembly (see FIG. 5). The movement of the ejector plate 22 causes the associated ejector pins 60 to extend into or to retract from the mold cavity 8. This drive arrangement for the actuators 26, 28 involves rotating the motor 68 in a first direction to cause the ejector pins 60 to move at a predetermined speed into the mold cavity 8, stopping movement after the preset ejection stroke is complete, and rotating the motor in a reverse direction to cause the ejector pins 60 to retract to their starting position. As will be more fully explained below, the actuators 26, 28 of such an electric ejector mechanism can be used in conjunction with a specially constructed golf ball mold having retractable core pins 16, 18 to center and hold a preformed core insert 12.

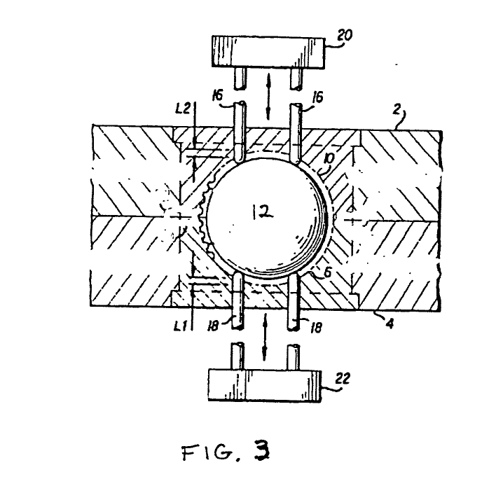

FIG. 3 shows portions of the upper mold segment 2 and the lower mold segment 4 with their respective hemispherical cavity sections 10, 6, which together form the spherical cavity 8 when the mold segments 2, 4 are closed. A spherical core insert 12 is suspended in the cavity 8 by the upper retractable pins 16 and lower retractable pins 18. Both sets of upper and lower pins 16, 18 are connected to respective upper and lower ejector plates 20, 22. The strokes L1 and L2 of the individual ejector plates 22, 20 connected to the retractable pins 16, 18 can be independently set and selected via the injection molding machine's microprocessor based control.

FIG. 4 shows the details of the preferred mold construction that cooperates with the electrically controlled actuators 26, 28 connected to the ejector plates 20, 22. While a single cavity golf ball mold is shown for purposes of illustration, the concepts of the present invention are equally applicable to multi-cavity mold constructions. As noted previously, the mold upper segment 2 and lower segment 4 together form the spherical mold cavity 8. Those knowledgeable in the art will understand that the mold segments 2, 4 are substantially similar in overall construction, except that the lower mold segment 4 further includes the ejector pins 60 for a runner 70 of material that feeds into the cavity 8. The retractable pins 16 and 18 are fitted in the respective mold segments 2, 4 and connected to the corresponding ejector plates 20, 22. Referring specifically to the elements of the lower mold segment 4 shown in FIG. 4, the intermediate forward position of the ejector plate 22 is identified by reference no. 64, while the retracted position is identified by reference no. 66. A similar range of movement would also be applicable to upper ejector plate 20

When the electrically controlled actuators 26, 28 are machine mounted, as shown, the connection bars 30 are attached between the ejector plates 20, 22 and the actuators 26, 28. If the electrically controlled actuators are part of the mold construction (not shown), then the actuators are connected between the ejector plate 22 and the mold base plate 34 or the mold mounting surface 36 of the stationary platen 42 in the injection molding machine 1. The ejector plate 22 in the lower mold segment 4 is provided with recesses 40 to accept shouldered ejector pins 60, which are configured so that they are not moved when the retractable pins 18 are moved their forward position (ejector plate 22 at 64). When the ejector plate 22 is retracted (at 66), the retractable pins 18 are also retracted but the recesses 40 still prevent the ejector pins 60 from being moved. However, when the molding process is complete and the mold segments 2, 4 have separated during the clamp opening phase, the ejector plate 22 is moved past the pre-set retractable pin forward position set point, so that the shoulder of the ejector pin 60 in the recess 40 is engaged by the plate 22 to allow for ejection of the finished golf ball from the mold cavity section 6 and the runner 70 from the lower mold segment 4.

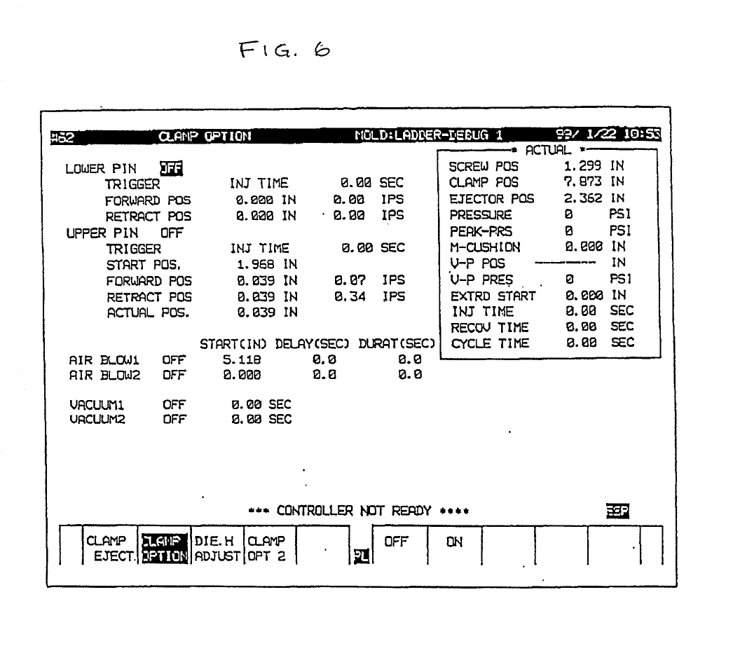

FIG. 6 shows an example of a parameter setting screen used by the operator to enter the information required by the machine control to operate the electrically driven actuators for the retractable pins. In particular, the relevant parameters shown in this representative screen include:

Lower Pin ON/OFF

ON: Lower Pin (Ejector pin) moves to lower pin “Forward Position” when the clamp reaches lock-up position.

Lower Pin Trigger

Injection Pressure: When the actual injection pressure exceeds the setting pressure during the injection process, lower pin starts to move to the lower pin “Retract Position”.

Injection Time: When the injection time exceeds the setting time, lower pin starts to move to the lower pin “Retract Position.”

Screw Position: When the actual screw position reaches the setting position, lower pin starts to move to the lower pin “Retract Position.”

The injection process starts when the lower pin reaches the lower pin “Forward Position”.

If trigger requirement is not made in injection or packing process, trigger is forcedly switched “ON” at starting of extruder sequence.

Lower Pin Forward and Retract Position

Setting range: 0.000 inch through specified maximum stroke limit of the machine.

Upper Pin ON/OFF

ON: Upper pin sequence is available. Clamp closing sequence in automatic/semi-automatic cycle is allowed only when Upper Pin is in forward position. Manual upper pin operation is available.

OFF: Upper pin sequence is not available. Clamp closing sequence in automatic/semi-automatic cycle is allowed only when Upper Pin is in Retract Position. Manual upper pin operation is not available.

Upper Pin Trigger

Injection Pressure: When the actual injection pressure exceeds the setting pressure during injection process upper pin starts to move to the upper pin “Retract Position”.

Injection Time: When the injection time exceeds the setting time, upper pin starts to move to the upper pin “Retract Position”.

Screw Position: When the actual screw position reaches the setting position, upper pin starts to move to the upper pin “Retract Position”.

If trigger requirement is not made in injection or packing process, trigger is forcedly switched “ON” at starting of extruder sequence.

Upper Pin Start Position

When the actual clamp position reaches this position, upper pin starts to move forward. Current cycle is not finished until upper pin reaches “Forward Position”.

Upper Pin Forward and Retract Position

Setting range: 0.000 inch through specified maximum stroke limit of the machine.

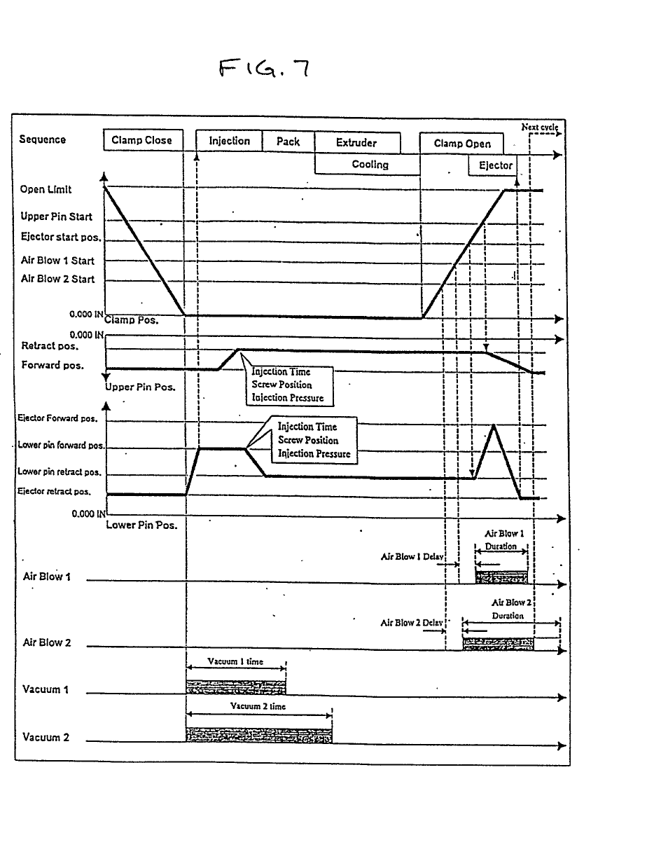

The sequence and timing for a typical molding cycle is shown by the chart in FIG. 7. The operator has previously set the machine operating parameters, including those associated with the pins 16, 18 driven by the actuators 26, 28, as reflected by the control set-up screen shown in FIG. 6. Generally speaking, the cycle begins by placing the preformed core insert 12 in the cavity section 6 in the lower mold segment 4. The upper core pins 16 are in their pre-set forward support position and the clamp mechanism 24 of the injection molding machine 1 is operated to closed the mold, as previously described, so that the core insert 12 is confined within the spherical cavity 8. The ejector plate 22 in the lower mold segment 4 is then moved by the associated electric actuator 28 to move the lower pins 18 to their pre-set forward support position, so that the upper pins 16 and lower pins 18 together hold the core 12 in the desired central position with the cavity 8.

As soon as the core 12 is properly supported, the thermoplastic material for the cover layer is injected into the mold cavity 8 to surround the core 12. The motors for the actuators 26, 28 are operated so that the upper pins 16 and lower pins 18 are retracted to their rearward preset position, after injection has progressed to the point where it is no longer necessary for the pins 16, 18 to support the core 12. Additional cover material is packed into the cavity 8 to fill the voids momentary left by the retraction of the pins 16, 18.

When the molded part has sufficiently cooled, the clamp mechanism 24 is operated to open the mold, separating the mold segments 2, 4. If desired, the upper ejector plate 20 can be set to move forward during the opening phase so that the upper pins 16 extend into the upper cavity section 10 of mold segment 2, thereby ensuring that the molded parts remain in the lower mold segment 4. The lower ejector plate 22 is then moved by the associated actuator 28 to the preset extreme forward position so that the core pins 18 eject the finished part from the lower cavity section 6 and the ejector pins 60 are moved to eject the runner 70 from the lower mold segment 4. After the part is removed, the lower core pins 18 (and ejector pins 60) retract to their reward position, while the upper core pins 16 move to their preset forward position. A new core 12 is then placed in the lower cavity section 6, just prior to the mold closing as a new cycle begins.

Although particular embodiments of the present invention have been illustrated and described, it will be apparent to those skilled in the art that various changes and modification can be made without departing from the concepts of the present invention. It is therefore intended to encompass within the appended claims all such changes and modification that fall within the scope of the present invention.

What is claimed is:

1. A method for injection molding a part having an outer layer covering a preformed core, using a mold having a plurality of retractable pins to support the core within a cavity and a linear actuator driven by an electric motor for moving the pins, comprising the steps of:
(a) inserting the core into a portion of the mold cavity,
(b) operating the motor to drive the linear actuator forwardly, thereby advancing the pins to a predetermined forward position, such that the pins support the core and position it at a desired orientation relative to the mold cavity,
(c) injecting a cover material to fill the mold cavity, thus applying the outer layer onto the core,
(d) operating the motor, when certain preset operating conditions are met, to drive the linear actuator rearwardly, thereby retracting the pins to a predetermined retract position, and
(e) removing the finished part from the mold cavity.

2. The method of claim 1, wherein step (d) further comprises injecting additional cover material into the mold cavity to fill voids left by retraction of the pins.

3. The method of claim 1, wherein the linear actuator driven by the motor in step (b) is an eject mechanism.

4. A method for injection molding a part having an outer layer covering a preformed core, using an injection molding machine with a mold having a plurality of retractable pins to support the core within a cavity and a linear actuator driven by a electric motor for moving the pins, comprising the steps of:
(a) opening the mold to expose the mold cavity,
(b) inserting the core into a portion of the mold cavity,
(c) closing the mold to confine the core within the mold cavity,
(d) operating the motor to drive the linear actuator forwardly, thereby advancing the pins to a predetermined forward position, such that the pins support the core and position it at a desired orientation relative to the mold cavity,
(e) injecting a cover material to fill the mold cavity, thus applying the outer layer onto the core,
(f) operating the motor, when certain preset operating conditions are met, to drive the linear actuator rearwardly, thereby retracting the pins to a predetermined retract position,
(g) injecting additional cover material into the mold cavity to fill voids left by retraction of the pins and
(h) operating the motor to drive the linear actuator forwardly, thereby ejecting the part from the mold cavity.

5. The method of claim 4 wherein operating the motor to drive the linear actuator forwardly, as set forth in step (h), also serves to eject a material supply runner from the mold.
